(19) United States
(12) Patent Application Publication
(10) Pub. No.: US 2022/0012074 A1
(43) Pub. Date: Jan. 13, 2022

(54) PROGRAM AND DEVICE FOR SCREEN SHARING

(71) Applicant: KONICA MINOLTA, INC., Tokyo (JP)

(72) Inventor: Masanori NISHIDA, Hyogo (JP)

(73) Assignee: KONICA MINOLTA, INC., Tokyo (JP)

(21) Appl. No.: 17/349,326

(22) Filed: Jun. 16, 2021

(30) Foreign Application Priority Data
Jul. 10, 2020 (JP) 2020-118950

(51) Int. Cl. G06F 9/451; G06F 9/54; H04L 29/08

(52) U.S. Cl. CPC G06F 9/452; H04L 67/10; G06F 9/547

(57) ABSTRACT

Provided is a non-transitory recording medium storing a computer readable program for screen sharing, the program causing one or more processors to perform: acquiring a drawing command issued by an application to an operating system (OS); and transmitting the drawing command to a terminal on a receiving side.

The entire disclosure of Japanese patent Application No. 2020-118950, filed on Jul. 10, 2020, is incorporated herein by reference in its entirety.

### BACKGROUND

### Technological Field

The present disclosure relates to screen sharing between devices, and more specifically relates to information transmitted and received between devices.

### Description of the Related Art

In recent years, screen sharing tools such as online conference tools have become widespread. In addition to voice and video calls, some screen sharing tools include a screen sharing function for sharing the entire screen of a display or the screen (dialog) of a specific application among a plurality of computers. In a conventional screen sharing tool, a computer on a transmitting side captures all or a part of the screen displayed on a display and transmits acquired image data to a computer on a receiving side. Further, the computer on the receiving side displays the received image data as it is on a display.

On the other hand, computers in recent years are provided with a function of high contrast display or the like for users with color vision variations. However, such a computer cannot apply settings for users with color vision variations to the image data received by the screen sharing tool. Therefore, there has been a problem that it is difficult for a conference participant having color vision variations to recognize the screen shared by the screen sharing tool.

Regarding screen sharing, for example, JP 2013-137669 A discloses a terminal device that “stores a setting information table storing setting information defining restrictions on display of object images of an icon image, a background image, or the like or restrictions on remote operations for every screen sharing partner when screen sharing is performed on a home screen in which an object image corresponding to a program executed by the own device is arranged. When the terminal device to be a host terminal specifies an external device to be a partner of screen sharing, the terminal device refers to the setting information table and sets the screen sharing so as to restrict display of the object images or remote control from the external device according to the setting information corresponding to the specified external device. After setting the screen sharing, the terminal device to be the host terminal performs the screen sharing with the guest terminal by sharing the home screen while restricting display of the object images or restricting the remote control” (see [Summary]).

Further, other techniques related to the screen sharing are disclosed in, for example, JP 2012-203485 A.

By the techniques disclosed in JP 2013-137669 A and JP 2012-203485 A, it is not possible to convert a shared screen into a format that is easy for users having color vision variations to recognize. Therefore, for example, there is a need for a technique for sharing a drawing command in which drawing settings can be changed among a plurality of terminals.

### SUMMARY

The present disclosure has been made in view of the above background, and an object in a certain aspect is to provide a technique for sharing a drawing command in which drawing settings can be changed among a plurality of terminals.

To achieve the abovementioned object, according to an aspect of the present invention, there is provided a non-transitory recording medium storing a computer readable program for screen sharing, and the program reflecting one aspect of the present invention causes one or more processors to perform: acquiring a drawing command issued by an application to an operating system (OS); and transmitting the drawing command to a terminal on a receiving side.

### BRIEF DESCRIPTION OF THE DRAWINGS

The above and other objectives, advantages, aspects, and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a mechanism in which a screen is displayed on a display of a terminal such as a personal computer;

FIG. 2 is a diagram illustrating a first example of a screen sharing tool;

FIG. 3 is a diagram illustrating an example of an internal operation of the terminal on a transmitting side in which the screen sharing tool is installed;

FIG. 4 is a diagram illustrating an example of an internal operation of the terminal on a receiving side in which the screen sharing tool is installed;

FIG. 5 is a diagram illustrating a second example of a screen sharing tool;

FIG. 6 is a diagram illustrating an example of an internal operation of the terminal on the transmitting side in which a screen sharing tool is installed;

FIG. 7 is a diagram illustrating an example of an internal operation of the terminal on the receiving side in which the screen sharing tool is installed;

FIG. 8 is a diagram illustrating a third example of a screen sharing tool;

FIG. 9 is a diagram illustrating an example of a configuration of a terminal capable of executing a screen sharing tool according to a certain embodiment;

FIG. 10 is a flowchart illustrating an example of a processing procedure for displaying and sharing a screen on the terminal on the transmitting side; and

FIG. 11 is a flowchart illustrating an example of a processing procedure for displaying and sharing a screen on the terminal on the receiving side.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same parts are designated by the same reference numerals. Their names and functions are the same. Therefore, the detailed description of them will not be repeated.

### A. Operation Example of Screen Sharing Tool for Transmitting and Receiving Image Data

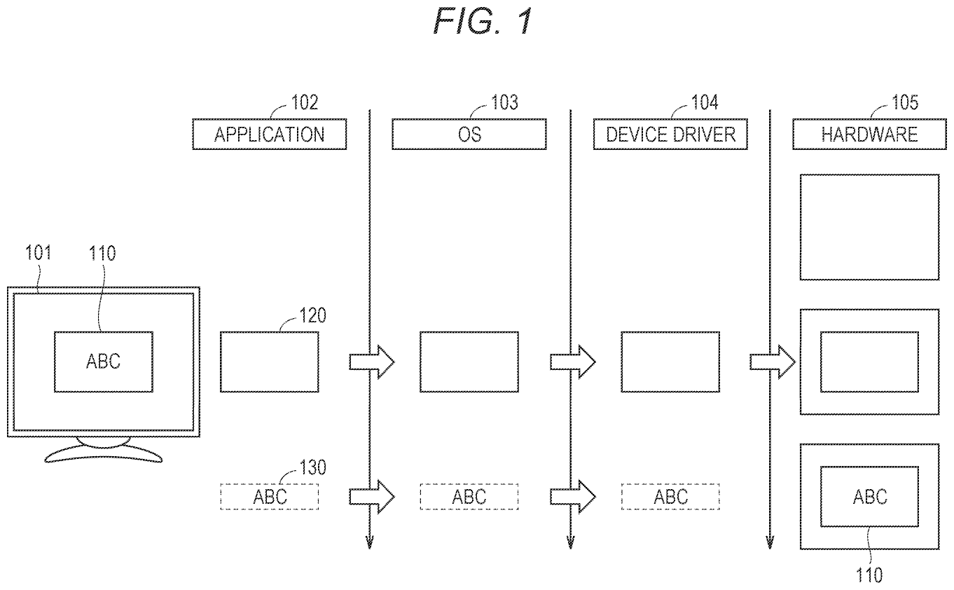

First, with reference to FIGS. 1 to 4, a mechanism for transmitting and receiving image data using a screen sharing tool, and shares a screen displayed on a display or a dialog of a specific application will be described.

FIG. 1 is a diagram illustrating an example of a mechanism in which a screen is displayed on a display of a terminal such as a personal computer. A flow until a dialog 110 of an application 102 is displayed on a display of a terminal 101 will be described with reference to FIG. 1. The terminal 101 retains the installed application 102, an operating system (OS) 103, and a device driver 104. Further, the device driver 104 and the application 102 operate on the OS 103. In a certain aspect, the terminal 101 may be a personal computer, a tablet, a smartphone, a game console having a communication function, and any other information processing device.

First, the application 102 transmits a drawing command including shape data 120 and text 130 to the OS 103. The shape data 120 may include, for example, all but text information such as the shape and image of a dialog of the application 102. The text 130 includes text information displayed on the dialog 110. The drawing command transmitted from the application 102 to the OS 103 is a drawing command that does not include hardware-dependent parameters and the like (hereinafter may be referred to as an “abstract drawing command”).

Next, the OS 103 transmits a drawing command for the shape data 120 and the text 130 to the device driver 104. The OS 103 selects the device driver 104 for controlling the hardware of the terminal 101, and transmits the drawing command to the device driver 104. The drawing command transmitted from the OS 103 to the device driver 104 is a drawing command including hardware-dependent parameters and the like (hereinafter may be referred to as a “concrete drawing command”).

The device driver 104 generates image data based on the concrete drawing command, and transmits the image data to hardware 105 of the terminal 101. The hardware 105 is, for example, the display of the terminal 101. The image data is generated as image data in which the shape data 120 and the text 130 included in the concrete drawing command are combined.

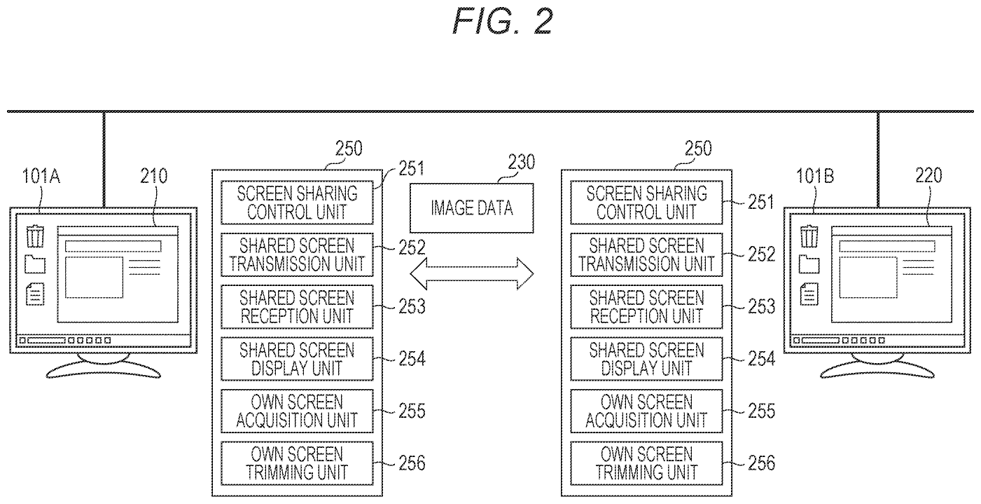

FIG. 2 is a diagram illustrating a first example of the screen sharing tool. Next, with reference to FIG. 2, the flow in which terminals 101A, 101B (collectively referred to as “terminal 101”) connected via a network share a screen using the screen sharing tool will be described.

In the example of FIG. 2, the terminal 101A shares the image of the display of the terminal 101A with the terminal 101B. That is, the terminal 101A is the terminal 101 on a transmitting side in screen sharing, and the terminal 101B is the terminal 101 on a receiving side.

Each of the terminals 101A, 101B retains an installed screen sharing tool 250. The display of the terminal 101A displays a dialog 210 of application. The display of the terminal 101B displays a dialog 220 of application.

The screen sharing tool 250 includes a screen sharing control unit 251, a shared screen transmission unit 252, a shared screen reception unit 253, a shared screen display unit 254, an own screen acquisition unit 255, and an own screen trimming unit 256.

The screen sharing control unit 251 controls the overall operation of the screen sharing tool 250. The shared screen transmission unit 252 transmits image data 230 for displaying a screen to be shared between the terminals 101A, 101B. The shared screen reception unit 253 receives the image data 230 for displaying the screen to be shared between the terminals 101A, 101B. The shared screen display unit 254 causes the received image data 230 to be displayed on the display of the terminal 101 on the receiving side. The own screen acquisition unit 255 receives the image displayed on the display of the terminal 101 on the transmitting side from the terminal 101 on the transmitting side. The own screen trimming unit 256 trims only the image of a necessary portion from the image received by the own screen acquisition unit 255. In the example of FIG. 2, the own screen trimming unit 256 trims only the image of the dialog 210 from the display image.

In the example illustrated in FIG. 2, the screen sharing tool 250 installed in the terminal 101A generates image data 230 of the dialog 210 displayed on the display of the terminal 101A, and transmits the image data 230 to the terminal 101B. The screen sharing tool 250 installed in the terminal 101B displays the dialog 220 on the display of the terminal 101B based on the received image data 230. Here, the image data 230 transmitted and received between the terminals 101A, 101B corresponds to the image data generated by the device driver 104 in FIG. 1.

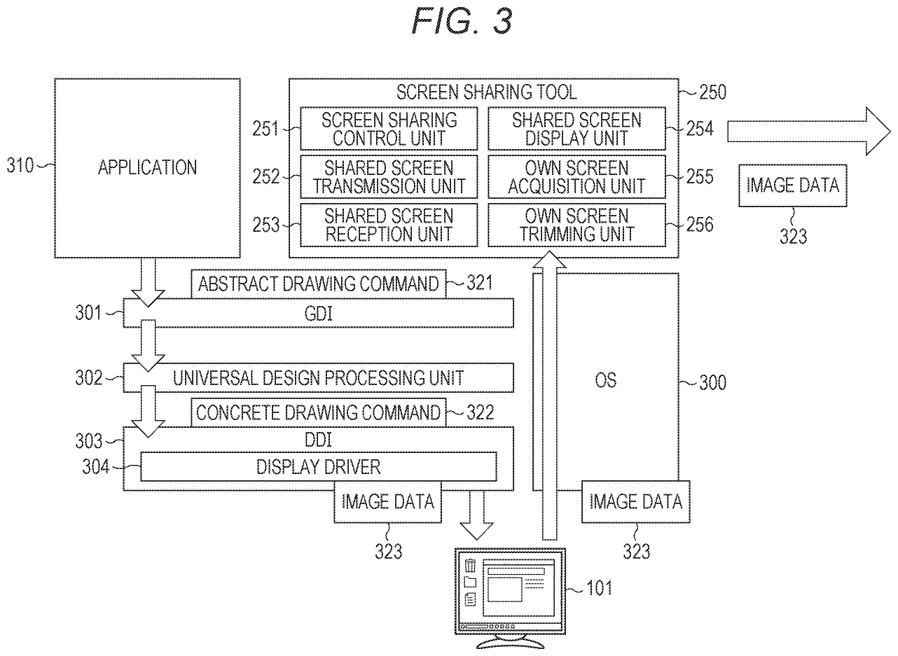

FIG. 3 is a diagram illustrating an example of an internal operation of the terminal 101 on the transmitting side in which the screen sharing tool 250 is installed. Operations of an application 310, an OS 300, and the screen sharing tool 250 running on the terminal 101 on the transmitting side will be described with reference to FIG. 3. The example illustrated in FIG. 3 corresponds to the internal operation of the terminal 101A transmitting the image data 230 of the dialog 210 in FIG. 2.

The OS 300 includes a graphics device interface (GDI) 301, a universal design processing unit 302, and a device driver interface (DDI) 303. The GDI 301 is an interface with each application installed in the OS. The GDI 301 receives an abstract drawing command 321 from the application 310. Further, the GDI 301 transmits the abstract drawing command 321 to the universal design processing unit 302.

The universal design processing unit 302 can reflect drawing settings (high contrast display, color filter function, change of character size, or the like) preset in the OS 300 on the abstract drawing command 321. Further, the universal design processing unit 302 generates a concrete drawing command 322 including information to be passed to various device drivers based on the abstract drawing command 321. The universal design processing unit 302 transmits the concrete drawing command 322 to the DDI 303.

The DDI 303 transmits the received concrete drawing command 322 to a display driver 304. The display driver 304 that has received the concrete drawing command 322 generates image data 323 based on the concrete drawing command 322. The image data 323 is displayed on the display of the terminal 101. The image data 323 corresponds to the dialog 210 in FIG. 2.

The screen sharing tool 250 receives the image data 323 via the OS 300 and transmits the image data 323 to the terminal 101 on the receiving side. This processing corresponds to the processing in which the screen sharing tool 250 installed in the terminal 101A in FIG. 2 transmits the image data 230 to the terminal 101B.

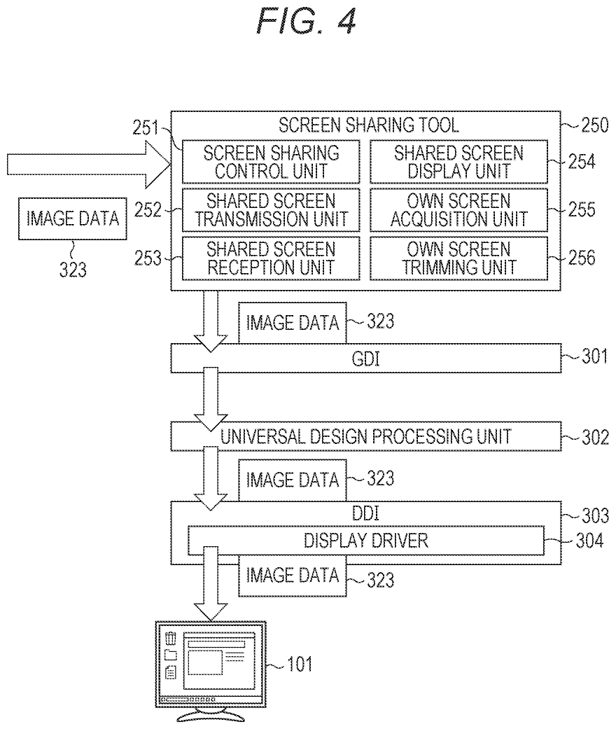

FIG. 4 is a diagram illustrating an example of an internal operation of the terminal 101 on the receiving side in which the screen sharing tool 250 is installed. The operation of the screen sharing tool 250 operating on the terminal 101 on the receiving side will be described with reference to FIG. 4. The example illustrated in FIG. 3 corresponds to the internal operation of the terminal 101B that receives the image data 230 of FIG. 2 and displays the dialog 220 on the display.

The screen sharing tool 250 receives the image data 323 and transmits the image data 323 to the GDI 301. The image data 323 is transferred in the order of the GDI 301, the universal design processing unit 302, and the DDI 303. Finally, the image data 323 is displayed on the display of the terminal 101 on the receiving side by the display driver 304.

Comparing FIGS. 3 and 4, it can be seen that there is a large difference between the image display process of the terminal 101 on the transmitting side and the image display process of the terminal 101 on the receiving side. At the terminal 101 on the transmitting side, the GDI 301 receives the abstract drawing command 321. By receiving the abstract drawing command 321, the OS 300 can reflect the drawing settings preset in the OS 300 on the abstract drawing command 321. For example, the OS 300 can reflect settings for visually impaired person or color vision variation holder, or the like on the abstract drawing command 321. By doing so, the OS 300 can generate the image data 323 that reflects the drawing settings suitable for the user of the terminal 101.

On the other hand, in the terminal 101 on the receiving side, the GDI 301 receives the image data 323 instead of the abstract drawing command 321. The universal design processing unit 302 cannot add the drawing settings preset in the OS 300 to the image data 323. Therefore, the OS 300 displays the received image data 323 as it is on the display. That is, the image displayed on the terminal 101 on the receiving side depends on the image data 323 generated by the terminal 101 on the transmitting side.

### B. Operation of Screen Sharing Tool for Transmitting and Receiving Drawing Command

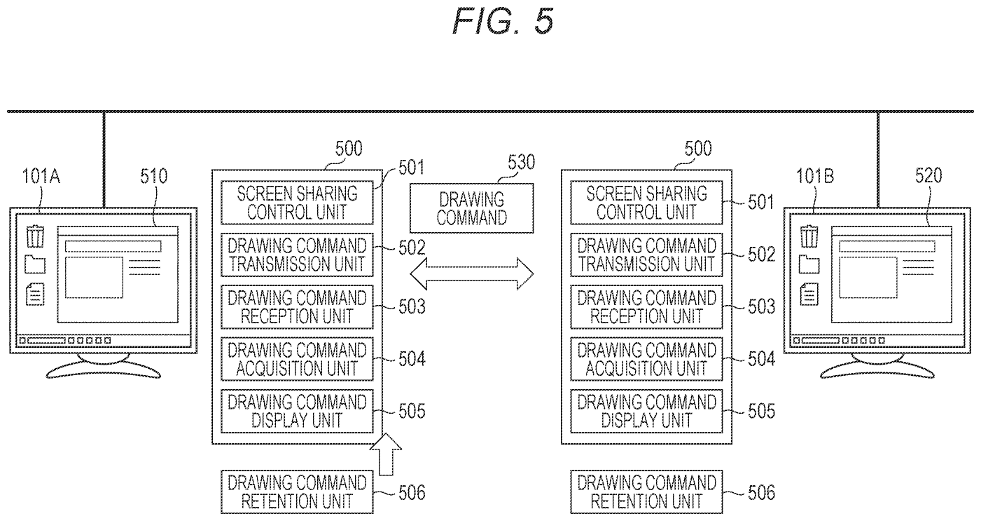

Next, with reference to FIGS. 5 to 8, a mechanism will be described in which a plurality of terminals transmits and receives drawing commands using a screen sharing tool, and shares a screen displayed on a display or a dialog of a specific application. The examples illustrated in FIGS. 5 to 8 differ from the examples of FIGS. 2 to 4 in that the screen is shared by transmitting and receiving a drawing command instead of image data.

FIG. 5 is a diagram illustrating a second example of the screen sharing tool. First, with reference to FIG. 5, a flow of sharing a screen by using a screen sharing tool in which the terminals 101A, 101B connected via a network transmit and receive a drawing command will be described. In the example of FIG. 5, the terminal 101A shares the image of the display of the terminal 101A with the terminal 101B. That is, the terminal 101A is the terminal 101 on a transmitting side in screen sharing, and the terminal 101B is the terminal 101 on a receiving side.

Each of the terminals 101A, 101B is equipped with an installed screen sharing tool 500. The display of the terminal 101A displays a dialog 510 of application. The display of the terminal 101B displays a dialog 520 of application.

The screen sharing tool 500 includes a screen sharing control unit 501, a drawing command transmission unit 502, a drawing command acquisition unit 503, a drawing command acquisition unit 504, and a drawing command display unit 505. Further, the screen sharing tool 500 cooperates with a drawing command retention unit 506. In a certain aspect, the screen sharing tool 500 may include the drawing command retention unit 506.

The screen sharing control unit 501 controls the overall operation of the screen sharing tool 500. The drawing command transmission unit 502 transmits a screen drawing command 530 to be shared between the terminals 101A, 101B to the terminal 101B on the receiving side. The drawing command acquisition unit 503 receives the screen drawing command 530 to be shared between the terminals 101A, 101B from the terminal 101A on the transmitting side. The drawing command acquisition unit 504 receives the drawing command 530 from the drawing command retention unit 506. The drawing command display unit 505 generates image data based on the drawing command 530 received by the drawing command acquisition unit 503, and displays the image data on the display of the terminal 101.

The drawing command retention unit 506 receives the drawing command 530 from each application or OS installed in the terminal 101. In a certain aspect, the drawing command retention unit 506 may request the drawing command 530 from the OS. Further, in another aspect, the drawing command retention unit 506 may directly receive the drawing command 530 from each application.

In the example illustrated in FIG. 5, the screen sharing tool 500 installed in the terminal 101A receives the drawing command 530 used to generate the dialog 510 displayed on the display of the terminal 101A, and transmits the drawing command 530 to the terminal 101B. The screen sharing tool 500 installed in the terminal 101B generates image data of the dialog 220 based on the received drawing command 530, and displays the dialog 220 on the display of the terminal 101B. Here, the drawing command 530 transmitted and received between the terminals 101A, 101B corresponds to the abstract drawing command transmitted from the application 102 to the OS 103 in FIG. 1.

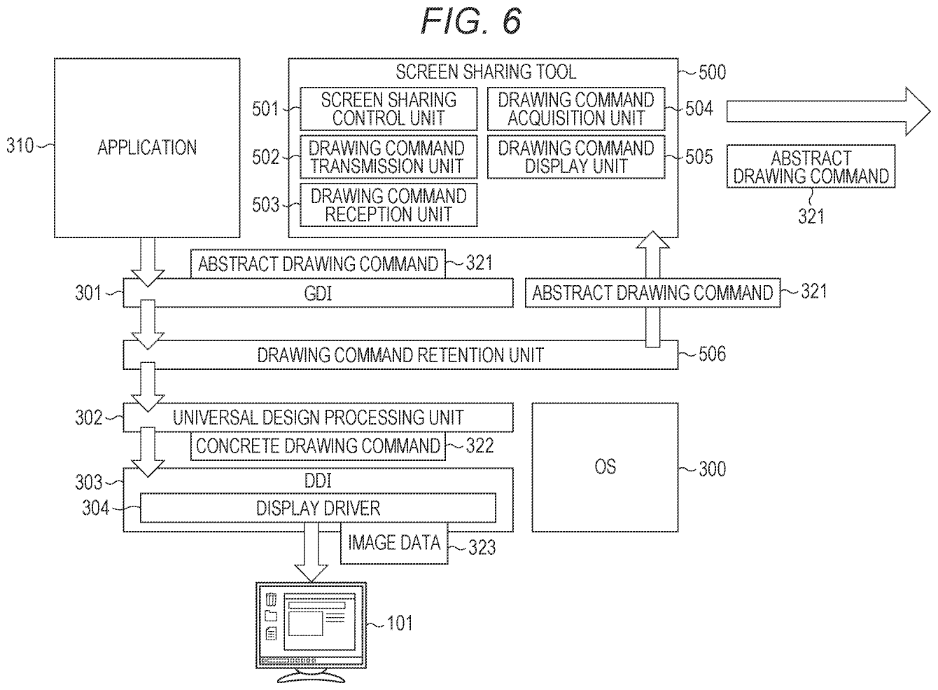

FIG. 6 is a diagram illustrating an example of an internal operation of the terminal 101 on the transmitting side in which the screen sharing tool 500 is installed. The operation of the application 310, the OS 300, and the screen sharing tool 500 running on the terminal 101 on the transmitting side will be described with reference to FIG. 6. The system configuration inside the terminal 101 illustrated in FIG. 6 is different from the system configuration inside the terminal 101 illustrated in FIG. 3 in that it includes the screen sharing tool 500 and the drawing command retention unit 506.

The GDI 301 receives an abstract drawing command 321 from the application 310. Further, the GDI 301 transmits the abstract drawing command 321 to the universal design processing unit 302. At that time, the GDI 301 also transmits the abstract drawing command 321 to the drawing command retention unit 506. In a certain aspect, the GDI 301 may also transmit the abstract drawing command 321 to the drawing command retention unit 506 based on the request from the drawing command retention unit 506. In another aspect, the drawing command retention unit 506 may directly receive the abstract drawing command 321 from the application 310.

The universal design processing unit 302 can reflect drawing settings (high contrast display, color filter function, change of character size, or the like) preset in the OS 300 on the abstract drawing command 321. Further, the universal design processing unit 302 generates a concrete drawing command 322 including information to be passed to various device drivers based on the abstract drawing command 321. The universal design processing unit 302 transmits the concrete drawing command 322 to the DDI 303.

The DDI 303 transmits the concrete drawing command 322 to the display driver 304. The display driver 304 that has received the concrete drawing command 322 generates the image data 323. The image data 323 is displayed on the display of the terminal 101. The image data 323 corresponds to the dialog 510 in FIG. 5.

The screen sharing tool 500 receives the abstract drawing command 321 from the drawing command retention unit 506, and transmits the abstract drawing command 321 to the terminal 101 on the receiving side. This processing corresponds to the processing in which the screen sharing tool 500 installed in the terminal 101A in FIG. 5 transmits a drawing command 530 to the terminal 101B.

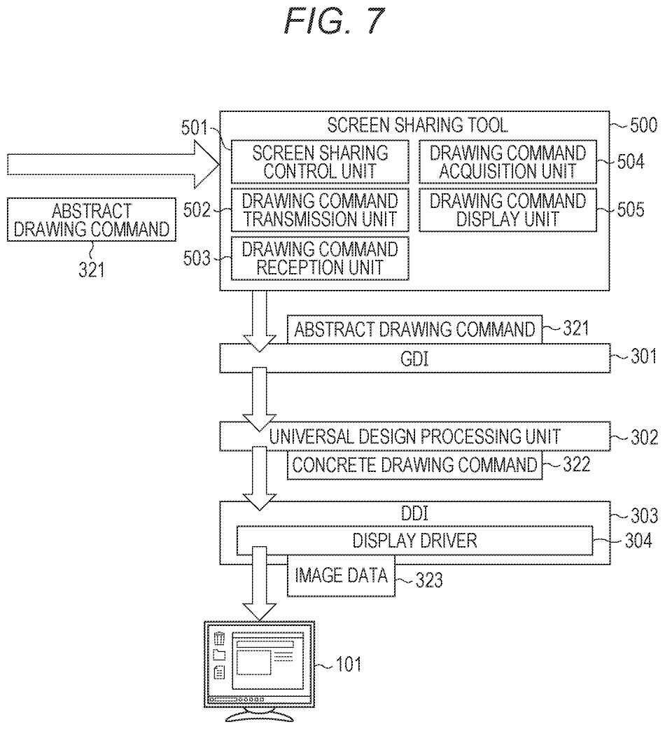

FIG. 7 is a diagram illustrating an example of the internal operation of the terminal 101 on the receiving side in which the screen sharing tool 500 is installed. The operation of the screen sharing tool 500 operating on the terminal 101 on the receiving side will be described with reference to FIG. 7. The system configuration inside the terminal 101 illustrated in FIG. 7 is different from the system configuration inside the terminal 101 illustrated in FIG. 4 in that it includes the screen sharing tool 500 and the drawing command retention unit 506.

The screen sharing tool 500 receives the abstract drawing command 321 and transmits the abstract drawing command 321 to the GDI 301. The GDI 301 transmits the received abstract drawing command 321 to the universal design processing unit 302.

The universal design processing unit 302 can reflect drawing settings (high contrast display, color filter function, change of character size, or the like) preset in the OS 300 on the abstract drawing command 321. Further, the universal design processing unit 302 generates a concrete drawing command 322 including information to be passed to various device drivers based on the abstract drawing command 321. Thereafter, the universal design processing unit 302 transmits the concrete drawing command 322 to the DDI 303.

The DDI 303 transmits the concrete drawing command 322 to the display driver 304. Upon receiving the concrete drawing command 322, the display driver 304 generates image data 323 and displays the image data 323 on the display of the terminal 101. The image data 323 corresponds to the dialog 520 in FIG. 5.

Comparing FIGS. 6 and 7, it can be seen that the process of displaying the image of the terminal 101 on the transmitting side and the process of displaying the image of the terminal 101 on the receiving side are the same. The screen sharing tool 500 transmits and receives an abstract drawing command 321. Therefore, not only the terminal 101A on the transmitting side but also the terminal 101B on the receiving side can generate the image data 323 based on the abstract drawing command 321. Thus, each of the terminal 101A and the terminal 101B that share the screen using the screen sharing tool 500 can generate the image data 323 using different drawing settings.

For example, it is assumed that the drawing settings of the OS 300 of the terminal 101A do not include special settings, and the drawing settings of the OS 300 of the terminal 101B include the high contrast display. In this case, the image data 323 displayed on the terminal 101A does not reflect the special drawing processing. On the other hand, the image data 323 displayed on the terminal 101B reflects the setting of the high contrast display.

As described with reference to FIGS. 6 and 7 above, the screen sharing tool 500 transmits the abstract drawing command 321 to the terminal 101 on the receiving side instead of the image data 323 generated by the display driver 304. In other words, the screen sharing tool 500 transmits data in a format in which the OS 300 can reflect the drawing settings to the terminal 101 on the receiving side.

The terminal 101 on the receiving side generates the image data 323 based on the received abstract drawing command 321. Thus, each terminal 101 can generate the image data 323 after reflecting the drawing settings set in the OS 300 of each terminal 101 on the abstract drawing command 321. Consequently, each terminal 101 can display the image data 323 that reflects the settings that are easy for the user of each terminal 101 to recognize on the display.

Note that in FIGS. 2 to 7, the respective functions of the screen sharing tools 250, 500 have been described using the terminal 101A on the transmitting side and the terminal 101B on the receiving side as examples, but the terminal 101 in which the screen sharing tool 250 or the screen sharing tool 500 is actually installed may have the functions of both the terminal 101A on the transmitting side and the terminal 101B on the receiving side.

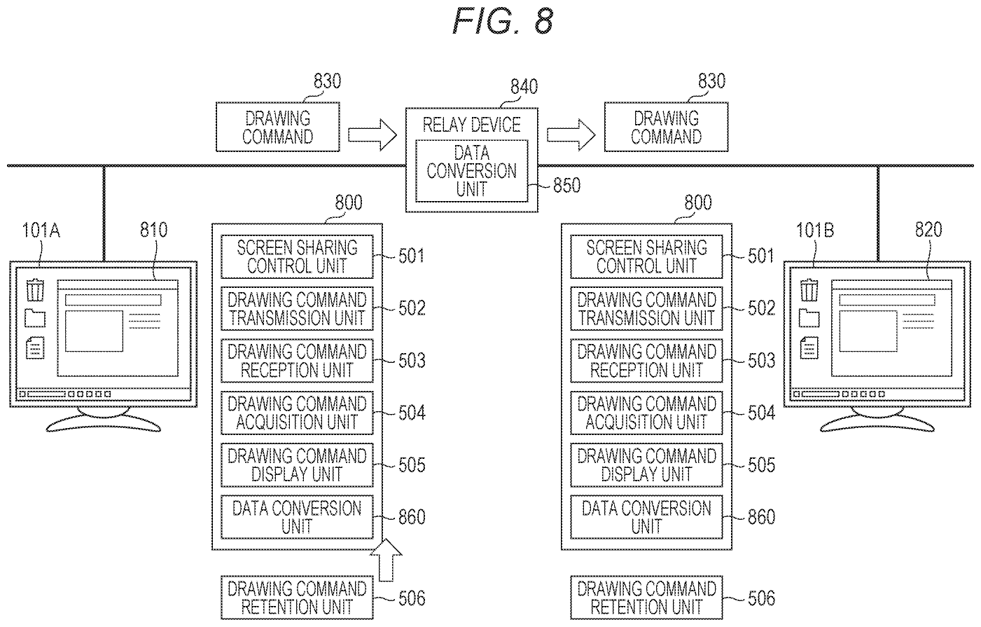

FIG. 8 is a diagram illustrating a third example of the screen sharing tool. Next, with reference to FIG. 8, a flow in which terminals 101A, 101B connected via a network transmit and receive drawing commands via a relay device 840 will be described.

In the example of FIG. 8, the terminal 101A shares an image of the display of the terminal 101A with the terminal 101B. That is, the terminal 101A is the terminal 101 on a transmitting side in screen sharing, and the terminal 101B is the terminal 101 on a receiving side. In addition, a different type of OS or a different version of the OS is installed in each of the terminals 101A, 101B. Furthermore, the screen sharing tool 800 is installed in each of the terminals 101A, 101B. A dialog 810 of application is displayed on the display of terminal 101A. A dialog 820 of application is displayed on the display of terminal 101B.

The relay device 840 relays data between the terminal 101A and the terminal 101B. For example, the terminal 101A and the terminal 101B can transmit and receive a drawing command 830 via the relay device 840. In a certain aspect, the relay device 840 may include a data conversion unit 850. In that case, the data conversion unit 850 can convert the format of the drawing command 830 based on the type and/or version of the OS of the terminal 101B on the receiving side. Further, in another aspect, the relay device 840 may receive information of the type and/or version of the OS and the like from each terminal 101A, 101B separately from the drawing command 830.

In a certain aspect, the screen sharing tool 800 may include a data conversion unit 860. In that case, the screen sharing tool 800 can convert the format of the drawing command 830 into a format that can be processed by the OS of the terminal 101B based on the type and/or version of the OS of the terminal 101B on the receiving side. In this case, the screen sharing toot 800 may exchange information such as the type and/or version of the OS of each terminal 101A, 101B with each other. Further, when the screen sharing tool 800 includes the data conversion unit 860, the drawing command 830 does not have to go through the relay device 840.

In a certain aspect, the terminal 101A may convert the format of the drawing command 830 before transmission into a format that can be processed by the OS of the terminal 101B by the data conversion unit 860. Further, in another aspect, the terminal 101B may convert the format of the received drawing command 830 into a format that can be processed by the OS of the terminal 101B by the data conversion unit 860.

In a certain aspect, the terminal 101A, 101B or the relay device 840 may convert the format of the drawing command 830 into any format independent of the OS instead of the format that can be processed by the OS of the terminal 101B on the receiving side. In that case, the data conversion unit 860 of the terminal 101B converts the format of the drawing command 830 into a format that can be processed by the OS of the terminal 101B based on the reception of the drawing command 830 whose format has been converted into the format independent of the OS.

As described above, the screen sharing tool 800 or the relay device 840 can convert the format of the drawing command 830 based on the type and/or version of the OS of the terminal 101 on the receiving side. With this function, for example, even if there is a difference in the type and/or version of the OS among a plurality of terminals 101 that shares the screen, the screen sharing tool 800 installed in each terminal 101 can exchange the drawing command 830 whose format has been properly converted. Consequently, the terminal 101 on the receiving side can reflect the drawing settings set in the OS on the drawing command 830 regardless of the type and/or version of the OS.

### C. Hardware Configuration

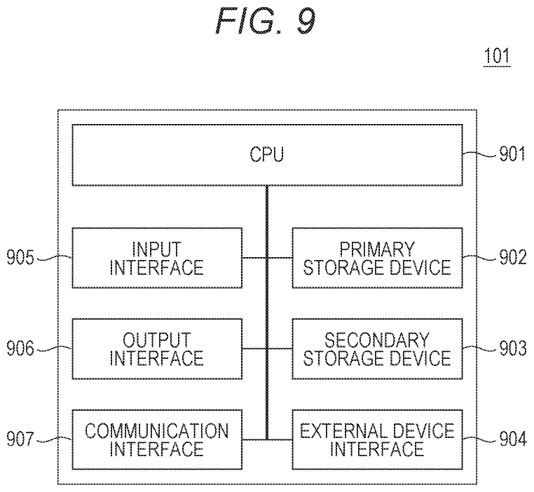

FIG. 9 is a diagram illustrating an example of a configuration of the terminal 101 capable of executing the screen sharing tool according to the present embodiment. The screen sharing tool 500, 800 or the like according to the present embodiment may be installed and executed as a program in the terminal 101.

The terminal 101 includes a CPU (Central Processing Unit) 901, a primary storage device 902, a secondary storage device 903, an external device interface 904, an input interface 905, an output interface 906, and a communication interface 907.

The CPU 901 can execute a program for implementing various functions of the terminal 101. The CPU 901 includes, for example, at least one integrated circuit. The integrated circuit may include, for example, at least one CPU, at least one FPGA (Field Programmable Gate Array), or a combination thereof or the like.

The primary storage device 902 stores programs executed by the CPU 901 and data referenced by the CPU 901. In a certain aspect, the primary storage device 902 may be implemented by a dynamic random access memory (DRAM) or a static random access memory (SRAM) or the like.

The secondary storage device 903 is a non-volatile memory and may store programs executed by the CPU 901 and data referenced by the CPU 901. In that case, the CPU 901 may execute a program read from the secondary storage device 903 to the primary storage device 902, and refers to the data read from the secondary storage device 903 to the primary storage device 902. In a certain aspect, the secondary storage device 903 may be implemented by a hard disk drive (HDD), a solid state drive (SSD), an erasable programmable read only memory (EPROM), an electrically erasable programmable read only memory (EEPROM), a flash memory, or the like.

The external device interface 904 can be connected to any external device such as a printer, scanner and an external HDD. In a certain aspect, the external device interface 904 may be implemented by a Universal Serial Bus (USB) terminal or the like.

The input interface 905 can be connected to any input device such as a keyboard, a mouse, a touchpad, or a gamepad. In a certain aspect, the input interface 905 may be implemented by a USB terminal, a PS/2 terminal, a Bluetooth (registered trademark) module, or the like.

The output interface 906 can be connected to any output device such as a cathode ray tube display, a liquid crystal display, or an organic electro-luminescence (EL) display. In a certain aspect, the output interface 906 may be implemented by a USB terminal, a D-sub terminal, a Digital Visual Interface (DVI) terminal, a High-Definition Multimedia Interface (HDMI) (registered trademark) terminal, or the like.

The communication interface 907 is connected to a wired or wireless network device. In a certain aspect, the communication interface 907 may be implemented by a wired local area network (LAN) port, a Wireless Fidelity (Wi-Fi) (registered trademark) module, or the like. In another aspect, the communication interface 907 may transmit and receive data using a communication protocol such as TCP/IP (Transmission Control Protocol/Internet Protocol) and User Datagram Protocol (UDP).

### D. Flowchart

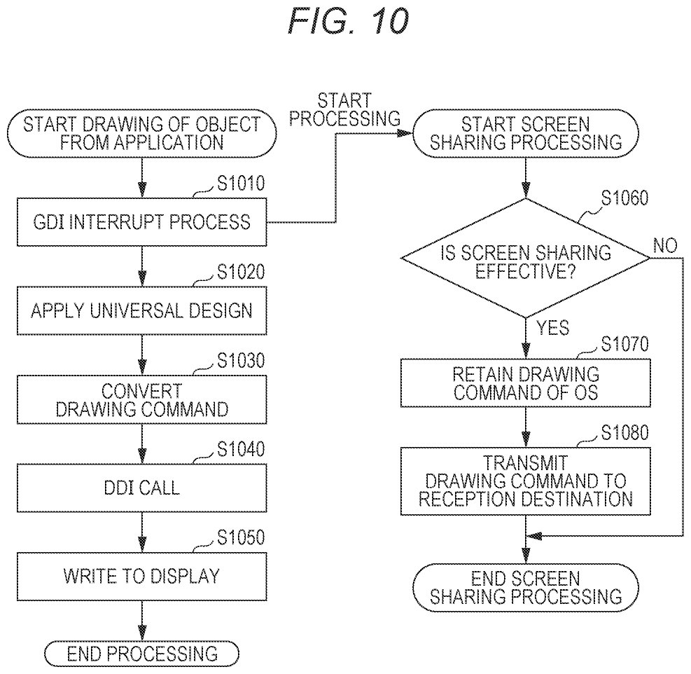

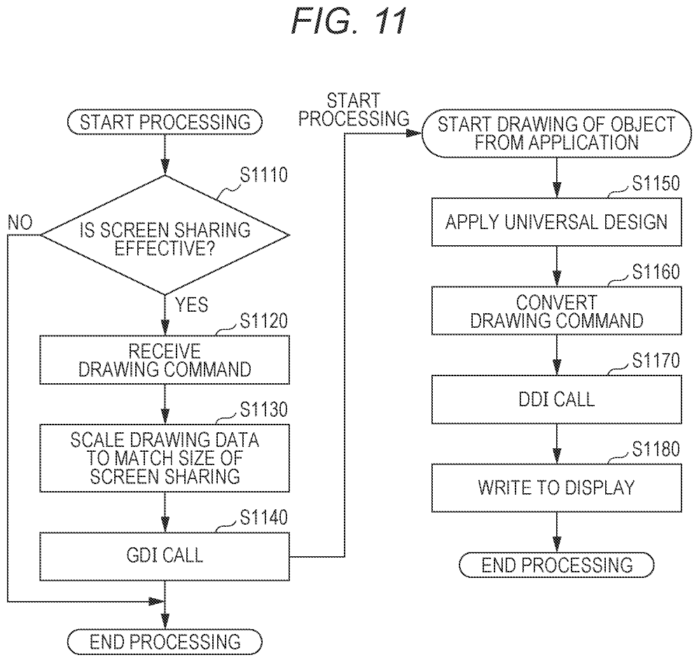

Next, a flow of processing of the screen sharing tool 500 according to the present embodiment will be described with reference to FIGS. 10 and 11. FIG. 10 is a flowchart illustrating an example of a processing procedure for displaying and sharing image data on the terminal 101 on the transmitting side. In a certain aspect, the CPU 901 may read the program for performing the processing of FIG. 10 from the secondary storage device 903 into the primary storage device 902 and execute the program. In a certain aspect, a part or all of the processing may also be implemented as a combination of circuit elements formed to execute the processing.

The CPU 901 can repeatedly execute processing of steps S1010 to S1050 and processing of steps S1060 to S1080 in parallel. The processing from steps S1010 to S1050 is processing related to display of image data on the display of the terminal 101. The processing from steps S1060 to S1080 is processing related to transmission of a drawing command by the screen sharing tool 500.

In step S1010, the CPU 901 executes a GDI interrupt process based on a GDI call, that is, transmission of the drawing command from the application to the OS. The GDI call corresponds to, for example, transmission processing of the abstract drawing command 321 to the GDI 301, which has been described with reference to FIG. 3 and the like. Further, the CPU 901 starts processing of screen sharing in steps S1060 to S1080 based on execution of the GDI interrupt process.

In step S1020, the CPU 901 executes application processing of universal design. The processing of this step corresponds to the processing of applying the drawing settings set in the OS 300 to the abstract drawing command 321 by the universal design processing unit 302, which has been described with reference to FIG. 3 and the like.

In step S1030, the CPU 901 converts the abstract drawing command into a concrete drawing command. The processing of this step corresponds to the processing of converting the abstract drawing command 321 into the concrete drawing command 322, which has been described with reference to FIG. 3 and the like.

In step S1040, the CPU 901 executes a DDI call. The processing of this step corresponds to the processing of transmitting the concrete drawing command 322 to the DDI 303, which has been described with reference to FIG. 3 and the like.

In step S1050, the CPU 901 displays a dialog of application on the display of the terminal 101. The processing of this step corresponds to the processing of displaying the image data 323 on the display of the terminal 101 by the display driver 304, which has been described with reference to FIG. 3 and the like.

In step S1060, the CPU 901 determines whether or not the screen sharing function is effective. For example, the CPU 901 determines whether or not the screen sharing function among a plurality of terminals 101 in the screen sharing tool 500 is effective. If the CPU 901 has determined that the screen sharing function is effective (YES in step S1060), the CPU 901 shifts control to step S1070. If not (NO in step S1060), the CPU 901 ends the processing of the screen sharing.

In step S1070, the CPU 901 retains the drawing command transmitted to the OS. The processing of this step corresponds to the processing described in FIG. 6 and the like in which the screen sharing tool 500 receives the abstract drawing command 321 via the drawing command retention unit 506.

In step S1080, the CPU 901 transmits a drawing command to the terminal 101 on the receiving side. The processing of this step corresponds to the processing of transmitting the abstract drawing command 321 to the terminal 101 on the receiving side by the screen sharing tool 500 described in FIG. 6 and the like.

FIG. 11 is a flowchart illustrating an example of a processing procedure for displaying and sharing image data on the terminal 101 on the receiving side. In a certain aspect, the CPU 901 may read a program for performing the processing of FIG. 11 from the secondary storage device 903 into the primary storage device 902 and execute the program. In a certain aspect, a part or all of the processing may also be implemented as a combination of circuit elements formed to execute the processing.

The CPU 901 can repeatedly execute processing of steps S1110 to S1140 and processing of steps S1150 to S1180 in parallel. The processing from steps S1110 to S1140 is processing related to reception of a drawing command by the screen sharing tool 500. The processing from steps S1150 to S1180 is processing related to display of image data on the display of the terminal 101.

In step S1110, the CPU 901 determines whether or not the screen sharing function is effective. For example, the CPU 901 determines whether or not the screen sharing function among a plurality of terminals 101 in the screen sharing tool 500 is effective. If the CPU 901 has determined that the screen sharing function is effective (YES in step S1110), the CPU 901 shifts control to step S1120. If not (NO in step S1110), the CPU 901 ends the processing of screen sharing.

In step S1120, the CPU 901 receives a drawing command from the terminal 101 on the transmitting side. In step S1130, the CPU 901 scales the received drawing command to match the size of the screen sharing. For example, the CPU 901 can change the size of the screen and the like included in the drawing command to match the terminal 101 on the receiving side. In step S1140, the CPU 901 executes a GDI call, that is, transmission of a drawing command from the application to the OS. Based on the occurrence of the GDI call, the CPU 901 starts the processing of steps S1150 to S1180.

In step S1150, the CPU 901 executes application processing of universal design. The processing of this step corresponds to the processing of applying the drawing settings set in the OS 300 to the abstract drawing command 321 by the universal design processing unit 302, which has been described with reference to FIG. 7 and the like.

In step S1160, the CPU 901 converts the abstract drawing command into a concrete drawing command. The processing of this step corresponds to the processing of converting the abstract drawing command 321 into the concrete drawing command 322, which has been described with reference to FIG. 7 and the like.

In step S1170, the CPU 901 executes a DDI call. The processing of this step corresponds to the processing of transmitting the concrete drawing command 322 to the DDI 303, which has been described with reference to FIG. 7 and the like.

In step S1180, the CPU 901 displays a dialog of application on the display of the terminal 101. The processing of this step corresponds to the processing of displaying the image data 323 on the display of the terminal 101 by the display driver 304, which has been described with reference to FIG. 7 and the like.

In a certain aspect, when the screen sharing tool 800 is installed in the terminal 101, the terminal 101 on the transmitting side may convert, for example, a drawing command before transmission into a drawing command in a format that can be processed by the OS of the terminal 101 on the receiving side, or a drawing command in a format independent of the OS by the data conversion unit 860, after the processing of step S1070.

In another aspect, when the screen sharing tool 800 is installed in the terminal 101, the terminal 101 on the receiving side may convert, for example, a drawing command after reception into a drawing command in a format that can be processed by the OS of the terminal 101 on the receiving side, or a drawing command in a format independent of the OS, by the data conversion unit 860 after the processing of step S1120.

In a certain aspect, the screen sharing tool 500, 800 may accept input of a command to switch between enable and disable of the screen sharing function. In that case, the screen sharing tool 500, 800 installed in the terminal on the transmitting side may request a drawing command from the OS or the application based on the acceptance of the input of the command. Further, the screen sharing tool 500, 800 may accept input of a command to switch between enable and disable of the screen sharing function from any input interface such as a keyboard, a mouse, a touch panel, or a microphone or the like.

In a certain aspect, the screen sharing tool 500, 800 installed in the terminal on the transmitting side may accept input of a selection command for information to be transmitted. The information to be transmitted includes, for example, a drawing command and image data. The screen sharing tool 500, 800 may transmit information of either the drawing command or the image data to the terminal 101 on the receiving side based on the acceptance of the input of the selection command for information to be transmitted. Further, the screen sharing tool 500, 800 may accept input of a selection command for information to be transmitted from any input interface such as a keyboard, a mouse, a touch panel, or a microphone or the like.

In the examples illustrated in FIGS. 2 to 11 described above, the screen sharing between two terminals 101 has been described, but the screen sharing tool 500, 800 according to the present embodiment can also be used for screen sharing between three or more terminals 101. When the screen sharing tool 500, 800 shares a screen among three or more terminals 101, the terminal 101 displaying the shared screen transmits a drawing command to all other terminals. All the other terminals 101 display image data on the display based on the received drawing command.

As described above, the terminals 101 in which the screen sharing tool 500 according to the present embodiment is installed share the abstract drawing command with each other. With this function, each terminal 101 can display image data on the display that reflects settings that are easy for the user of each terminal 101 to recognize.

Further, since the screen sharing tool 800 or the relay device 840 has the function of converting a drawing command, the screen sharing tool installed in each terminal 101 can exchange appropriately converted drawing commands even if there is a difference in type and/or version of the OS between the terminals 101 performing transmission and reception. Consequently, the terminal 101 on the receiving side can reflect the drawing settings set in the OS in the drawing command regardless of the type and/or version of the OS.

Although embodiments of the present invention have been described and illustrated in detail, the disclosed embodiments are made for purposes of illustration and example only and not limitation. The scope of the present invention should be interpreted by terms of the appended claims, and it is intended that all modifications are included in the meaning and scope equivalent to the claims. In addition, the disclosure contents described in the embodiments and the respective modification examples are intended to be implemented either alone or in combination as much as possible.

What is claimed is:

1. A non-transitory recording medium storing a computer readable program for screen sharing, the program causing one or more processors to perform:
acquiring a drawing command issued by an application to an operating system (OS); and
transmitting the drawing command to a terminal on a receiving side.

2. The non-transitory recording medium storing a computer readable program for screen sharing according to claim 1, wherein
the OS reflects a drawing setting preset in the OS on the drawing command, and
the drawing command is used by a device driver to generate image data to be displayed on a display.

3. The non-transitory recording medium storing a computer readable program for screen sharing according to claim 1, wherein
the acquiring the drawing command includes:
accepting a command to enable a screen sharing function; and
requesting the drawing command from the OS based on the acceptance of the command.

4. The non-transitory recording medium storing a computer readable program for screen sharing according to claim 1, further causing the one or more processors to perform:
accepting input of selection of transmission information; and
transmitting either the drawing command or image data to the terminal on the receiving side based on the accepting the input of the selection of the transmission information.

5. The non-transitory recording medium storing a computer readable program for screen sharing according to claim 1, further causing the one or more processors to perform:
receiving type information of the OS from the terminal on the receiving side; and
converting the drawing command based on the type information of the OS received from the terminal on the receiving side,
wherein the transmitting the drawing command to the terminal on the receiving side includes transmitting the drawing command after the converting the terminal on the receiving side.

6. The non-transitory recording medium storing a computer readable program for screen sharing according to claim 1, further causing the one or more processors to perform:
receiving version information of the OS from the terminal on the receiving side; and
converting the drawing command based on the version information of the OS received from the terminal on the receiving side,
wherein the transmitting the drawing command to the terminal on the receiving side includes transmitting the drawing command after the converting the terminal on the receiving side.

7. The non-transitory recording medium storing a computer readable program for screen sharing according to claim 1, further causing the one or more processors to perform converting the drawing command into a format independent of the OS,
wherein the transmitting the drawing command to the terminal on the receiving side includes transmitting the drawing command after the converting the terminal on the receiving side.

8. The non-transitory recording medium storing a computer readable program for screen sharing according to claim 1, further causing the one or more processors to perform:
receiving the drawing command from a terminal on a transmitting side;
generating an image based on a drawing setting of a figure or/and a character set in the OS of the terminal on the receiving side and the drawing command; and
drawing the generated image on a display.

9. The non-transitory recording medium storing a computer readable program for screen sharing according to claim 8, further causing the one or more processors to perform converting the drawing command into a format corresponding to the OS of the terminal on the receiving side based on that a format or a parameter of the received drawing command does not correspond to the OS of the terminal on the receiving side.

10. A non-transitory recording medium storing a computer readable program for screen sharing, the program causing one or more processors to perform:
receiving a drawing command transmitted and received between a plurality of terminals;
converting, based on presence of a difference between an operating system (OS) of a terminal on a transmitting side of the drawing command and an OS of a terminal on a receiving side of the drawing command, the drawing command into a format processable by the OS of the terminal on the receiving side; and
transmitting the drawing command after the converting to the terminal on the receiving side.

11. A device comprising:
a memory that stores the non-transitory recording medium storing the computer readable program for screen sharing according to claim 1; and
one or more processors that execute the program.

12. A device comprising:
a memory that stores the non-transitory recording medium storing the computer readable program for screen sharing according to claim 10; and
one or more processors that execute the program.
